(19) United States
(12) Patent Application Publication
(10) Pub. No.: US 2011/0116447 A1
(43) Pub. Date: May 19, 2011

(54) MEDIA PERFORMANCE MANAGEMENT

(75) Inventor: Robert A. DiFazio, Greenlawn, NY (US)

(73) Assignee: INTERDIGITAL PATENT HOLDINGS, INC., Wilmington, DE (US)

(21) Appl. No.: 12/947,600

(22) Filed: Nov. 16, 2010

Related U.S. Application Data
(60) Provisional application No. 61/261,623, filed on Nov. 16, 2009.

(51) Int. Cl. H04W 40/00

(52) U.S. Cl. 370/328

(57) ABSTRACT

A method and apparatus for performing media performance management are provided. A media performance controller (MPC) may control a media performance unit (MPU) to perform media flows. The MPC may detect events associated with the MPU, may evaluate the events, and may control the MPU in response to the events. The MPC may prioritize the events based on priority information associated with the media flows, the MPU, control units, media sources, users, communication links, relationships, policies, or other events associated with the events. The MPU may control the MPC to concurrently perform the media flows such that a first media flow my be performed using a first portion of a media performance capability of the MPU and a second media flow may be performed using a second portion of the media performance capability of the MPU.

### CROSS REFERENCE TO RELATED APPLICATIONS

This application claims the benefit of U.S. Provisional Application No. 61/261,623 filed Nov. 16, 2009, the contents of which are hereby incorporated by reference herein.

### BACKGROUND

A communication device, such as a wireless transmit/receive unit (WTRU), may participate in a communication session via an access network, such as a Universal Mobile Telecommunication System (UMTS) Terrestrial Radio Access Network (UTRAN), a Long Term Evolution (LTE) network, a Worldwide Interoperability for Microwave Access (WiMax) network, or a Wireless Local Area Network (WLAN) network. Accordingly, it would be advantageous to provide a method and apparatus for media performance management.

### SUMMARY

A method and apparatus for performing media performance management are provided. A media performance controller (MPC) may control a media performance unit (MPU) to perform media flows. The MPC may detect events associated with the MPU, may evaluate the events, and may control the MPU in response to the events. The MPC may prioritize the events based on priority information associated with the media flows, the MPU, control units, media sources, users, communication links, relationships, policies, or other events associated with the events. The MPU may control the MPC to concurrently perform the media flows such that a first media flow my be performed using a first portion of a media performance capability of the MPU and a second media flow may be performed using a second portion of the media performance capability of the MPU.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 2 shows a diagram of an example of a communication configuration for media performance management;

FIG. 3 shows a diagram of an example of a communication configuration for media performance management with an independent media performance unit;

FIG. 4 shows a diagram of another example of a communication configuration for media performance management with multiple independent media performance units;

FIG. 5 shows a flowchart of an example of media performance management;

FIG. 6 shows a diagram of an example of media performance management;

FIG. 7 shows a diagram of an example of media performance management with control unit identification;

FIG. 8 shows a diagram of an example of media performance management with priority information;

FIG. 9 shows a diagram of an example of media performance management with bidirectional communication; and

FIG. 10 shows a diagram of an example of a media performance unit.

### DETAILED DESCRIPTION

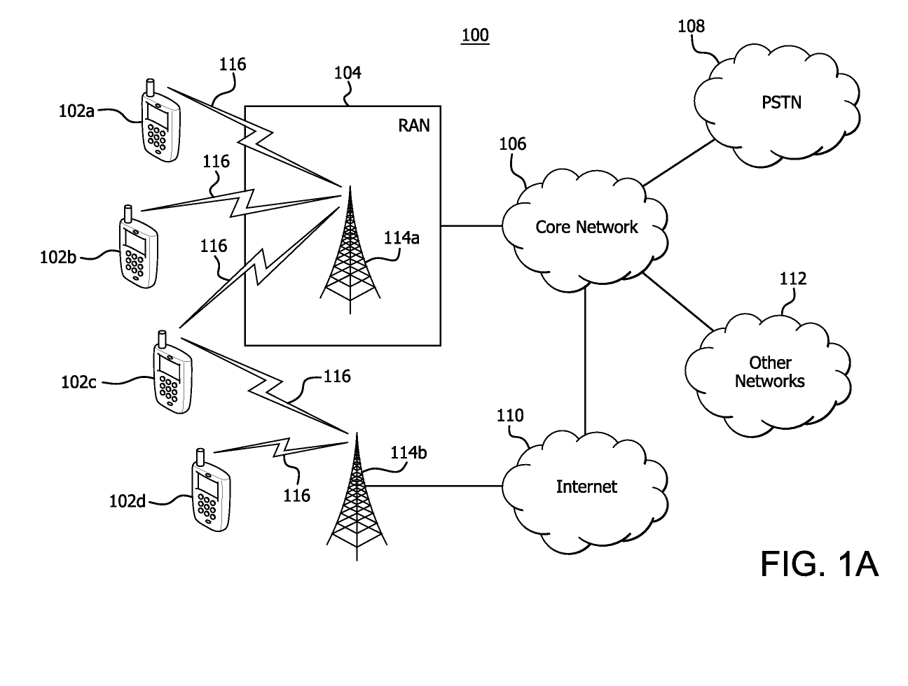

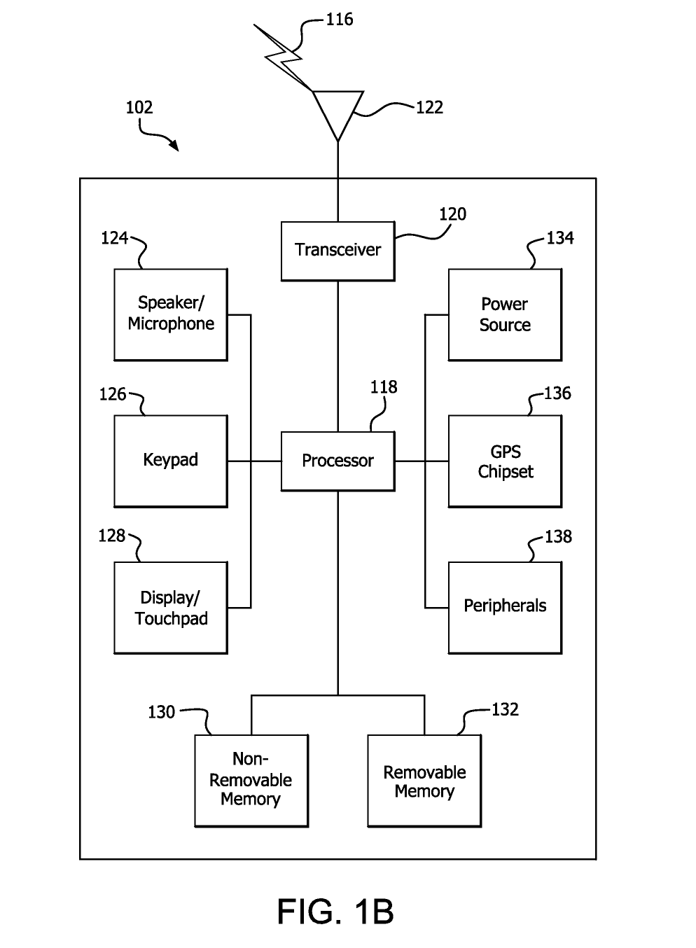

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Although shown as wireless units for simplicity, each of the WTRUs 102a, 102b, 102c, 102d may be any type of device configured to operate and/or communicate in a wired or wireless environment. By way of example, the WTRUs 102a, 102b, 102c, 102d may be configured to transmit and/or receive wired or wireless signals and may include user equipment (UE), a mobile station, a fixed or mobile subscriber unit, a pager, a cellular telephone, a personal digital assistant (PDA), a smartphone, a laptop, a netbook, a personal computer, a tablet, a wireless sensor, a display device, consumer electronics, a remote control, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link, (e.g., radio frequency (RF), microwave, infrared (IR), ultraviolet (UV), visible light, etc.) The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

Media performance management may include receiving, processing, and controlling the performance of one or more media flows, such as video media flows or audio media flows, using a media performance controller (MPC) and one or more media performance units (MPUs), such as a display, a projector, a speaker, or a printer. For example, a UE, such as the WTRU shown in FIG. 1B, may include a MPC and a MPU. The UE may receive control signals and media flows from one or more sources during a time period. The MPC may process the media flows and control signals, and may control the MPU to perform the media flows. A MPU maybe controlled to concurrently perform one or more media flows of a type by performing each media flow using a portion of the MPU's media performance capabilities.

For example, a video MPU may concurrently perform a first video media flow and a second video media flow. The video MPU may perform the media flows using a split screen method, wherein one video media flow is performed using the left half of the video display, and another video media flow is performed using the right half of the video display. In another example, the video MPU may perform the media flows using a picture-in-picture method wherein one video media flow is performed using a majority of the video display and the other video media flow is performed using a relatively small portion of the video display. In another example, the video MPU may perform the media flows using a rotation method wherein one video media flows is performed using the video display for a first period, and another video media flow is performed using the video display for a second period. In another example, the MPU may perform the media flows using a layering method wherein a different portion of each media flow is concurrently performed.

A request to perform a media flow may indicate a request to perform multiple associated media flows. A MPC may control one or more MPUs to perform each of the associated media flows. For example, a request to perform a first media flow may indicate a request to perform a video media flow and an associated audio media flow. A MPC may control a video MPU to perform the video media flow, and an audio MPU to perform the audio media flow. The video MPU and the audio MPU may be included in a single physical device, or may be physically independent devices. The request may include a request to perform a media flow using a specified MPU. The request may include a request to perform a media flow without performing one or more of the associated media flows.

For simplicity, a logical combination of a MPC and a MPU may be referred to herein as a UE; however, the MPC and the MPU may each be configured as one or more physically independent devices in communication with each other. For example, a UE may include a MPC controlling a single MPU in a single physical device, or a UE may include a MPC controlling multiple MPUs in multiple physically independent devices. The MPC may be configured as a single device or may include multiple coordinated physically independent devices.

The UE may receive control signals from one or more control units. Control signals may include requests, such as requests to perform media flows or requests to modify a priority. Control signals may include information, such as location information or status information for a remote device. The UE may include a control unit, such as a touch screen or keyboard, or a control unit may be an independent device, such as a WTRU as shown in FIG. 1B, in communication with the UE via a wired or wireless communication link.

Similarly, the UE may receive media flows from one or more media sources. The UE may include a media source, such as a data storage device, or a media source may be an independent device, such as a media server in communication with the UE via a wired or wireless communication link. The UE may perform intermediate processing, such as formatting or transcoding, of the media flows.

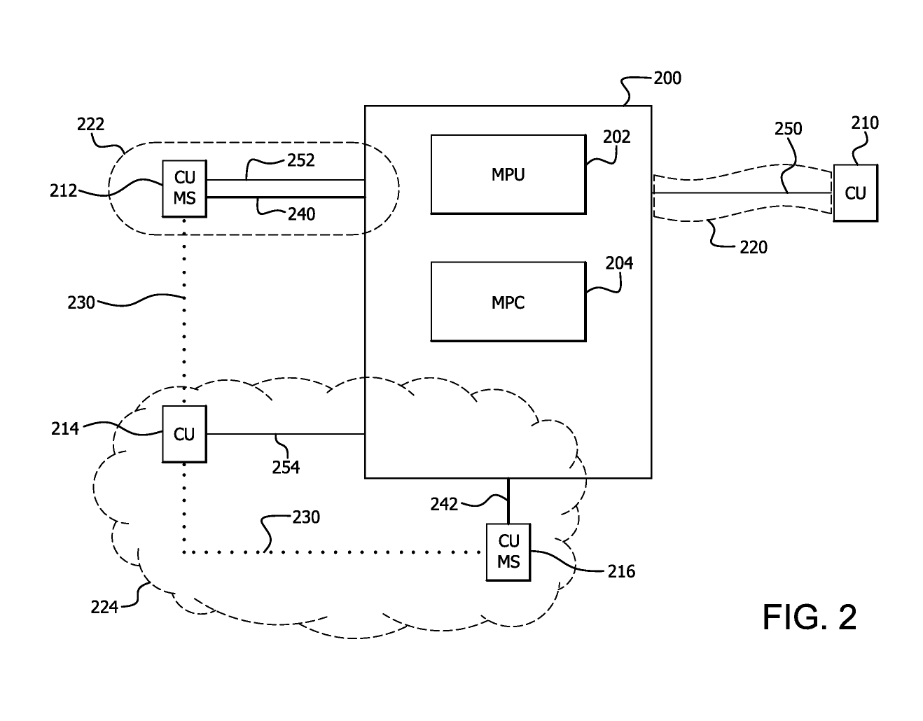

FIG. 2 shows a diagram of an example of a communication configuration for media performance management. A UE 200, including a MPU 202 and a MPC 204, may communicate with one or more remote devices 210/212/214/216. Each of the remote devices 210/212/214/216 may include a control unit (CU), which may send control signals to the UE 200, a media source (MS), which may send media flows to the UE 200, or both. Although not shown, the UE may include a control unit, a media source, or both.

The UE 200 and the remote devices 210/212/214/216 may communicate via any combination of wired or wireless communication links 220/222/224. For example, the UE 200 may communicate with a remote device 210 via a direct link 220, such as an infrared (IR) link or a direct wired link; the UE 200 may communicate with another remote device 212 via a LAN 222, such as a wired LAN or a WLAN; the UE 200 may communicate with other remote devices 214/216 via a WAN 224, such as a UTRA network. The remote devices 210/212/214/216 may communicate with each other via communication links 230.

The MPC 204 may process the media flows 240/242, the control signals 250/252/254, or both. In response to the control signals 250/252/254, the MPC 204 may determine which media flows 240/242 to perform during a time period and may control the MPU 202 to perform the media flows 240/242.

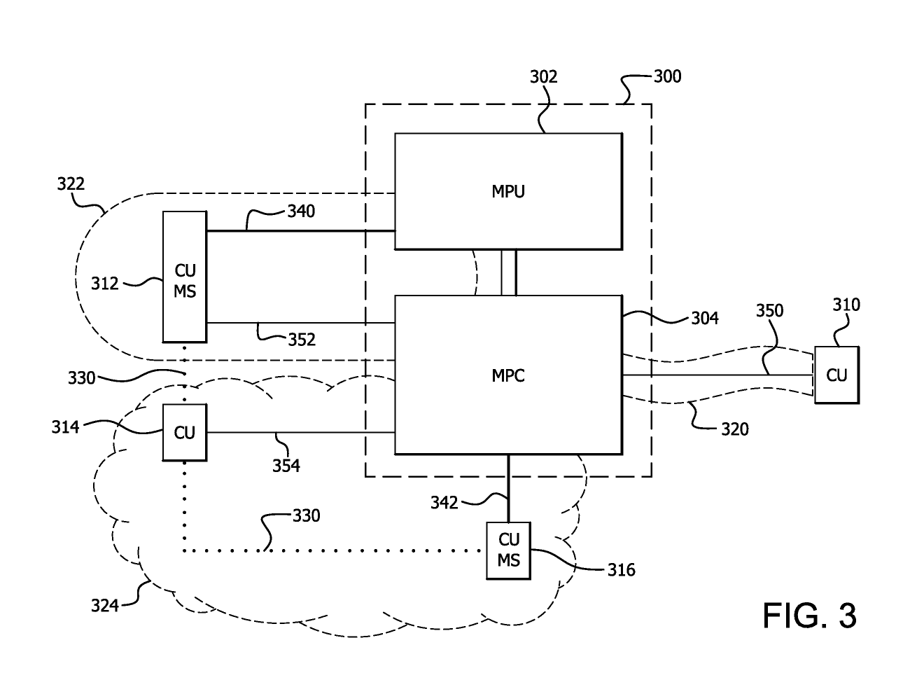

FIG. 3 shows a diagram of another example of a communication configuration for media performance management. The apparatus shown in FIG. 3 are similar to the apparatus shown in FIG. 2 except that the UE 300 is shown using a broken line to indicate that the MPU 302 and the MPC 304 may be separate physical devices in communication with each other. The MPU 302 and the MPC 304 may communicate via a wired or wireless communication link. For example, the MPU 302 may be connected to the MPC 304 via a USB cable, or the MPU 302 may communicate with the MPC 304 via the Internet. The MPU 302, the MPC 304, or both may communicate with one or more remote devices 310/312/314/316.

In the example shown, the MPU 302 may receive media flows 340 from remote devices 312. The MPC 304 may receive control signals 350/352/354 and media flows 342 from remote devices 310/312/314/316. The MPC 304 may process the control signals 350/352/354, the media flows 342/344, or both. In response to the control signals 350/352/354, the MPC 304 may determine which media flows 340/342/344 to perform during a time period and may control the MPU 302 to perform the media flows 340/342/344.

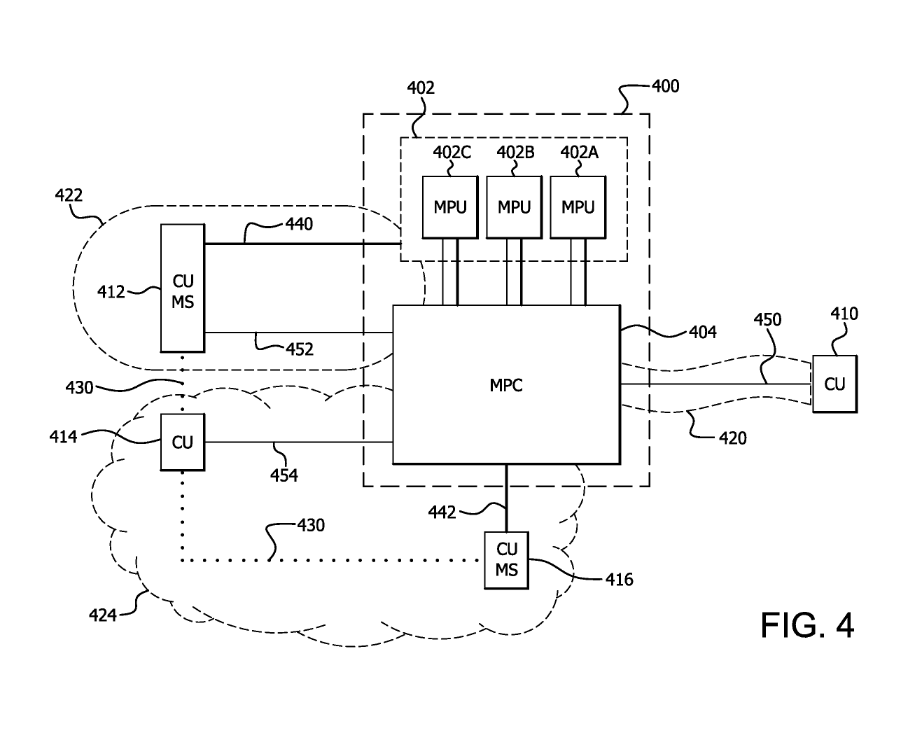

FIG. 4 shows a diagram of another example of a communication configuration for media performance management. The apparatus shown in FIG. 4 are similar to the apparatus shown in FIGS. 2 and 3 except that the MPU 402 is shown using a broken line to indicate that the MPU 402 may include multiple independent MPUs 402A/402B/402C in communication with the MPC. The MPU 402 may be configured as a single physical device including multiple independent MPUs 402A/402B/402C, or as one or more physically separate devices, each including one or more of the independent MPUs 402A/402B/402C.

The independent MPUs 402A/402B/402C, the MPC 404, or any combination thereof may communicate with one or more remote devices 410/412/414/416. The independent MPUs 402A/402B/402C and the MPC 404 may communicate with each other. The MPC 404 may control media performance on one or more of the independent MPUs 402A/402B/402C. Each independent MPU 402A/402B/402C may concurrently perform one or more media flows. A single media flow may be performed using one or more independent MPUs 402A/402B/402C.

In the example shown, the MPU 402 may receive media flows 440 from remote devices 412. The MPC 404 may receive control signals 450/452/454 and media flows 442 from remote device 410/412/414/416. The MPC 404 may process the control signals 450/452/454, the media flows 442, or both. In response to the control signals 450/452/454, the MPC 404 may determine which media flows 440/442 to perform during a time period and may control the MPU 402A/402B/402C to perform the media flows 440/442.

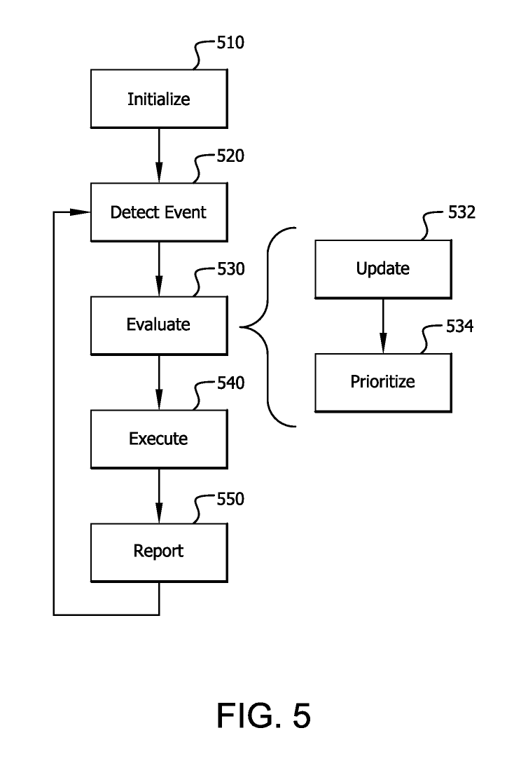

FIG. 5 is a flowchart of an example of media performance management. A MPC, such as the MPC shown in FIGS. 2-4, may be initialized at 510. Initialization may include powering on a powered-down MPC or re-initializing a powered-up MPC. Initialization may include starting or resetting timers. Initialization may include modifying the MPC. For example, the MPC may include policies for detecting and evaluating events, and may add, update, or delete the policies during initialization. Initialization may include initializing status information, for example, based on default parameters or prior status information.

The MPC may detect one or more events at 520. An event may be associated with one or more entities, such as users, control units, media sources, MPUs, or communication links. An event may be associated with an action, such as a request to perform a media flow or a policy indicating a powering down of a MPU.

Detecting an event may include detecting status information, such as a current or previous status of the MPC, an associated MPU, a communication link, an associated device, or an associated media flow. For example, the MPC may detect a proximity of a control unit or the MPC may detect an availability of a MPU. The MPC may detect time based events, such as the expiration of a timer or an occurrence of a time or date.

The MPC may detect execution based events, such as a successful or unsuccessful execution of an action; for example, the completion of initialization. Initialization may trigger events. For example, during initialization the MPC may trigger events to control the MPUs, to stop, start, or resume performance of a media flow, such as a media flow that was previously being performed, or a default media flow.

The MPC may detect events based on a change in an entity relationship, such as association, disassociation, or re-association of a user, a control unit, a MPU, a media source, or a communication link. The MPC may detect an event based on an addition, deletion, or modification of a media flow or a change in a quality of service of a communication session or media flow.

The MPC may detect events based on control signals. For example, the MPC may receive a control signal including a request to perform a media flow, to modify a priority, to power down the MPC, or to provide information, such as location information. The MPC may receive a control signal to indicate an acknowledgment or negative acknowledgment of a message, or to indicate user input.

The MPC may evaluate one or more events at 530. The evaluation may be based on entity relationship information, priority information, status information, event information, or policy information. Invalid events, such as duplicate, expired, impracticable events, or events that violate policies, may be rejected, deleted, or delayed. For example, a policy may indicate that a media flow may not be performed during a defined time period, and the MPC may reject or delay an event indicating a request to perform a media flow during the time period.

The evaluation may include authenticating entities, such as remote, media flows, and control signals. For example, the MPC may detect that a received media flow differs from a requested media flow, or that a requested media flow violates a policy. In another example, the MPC may detect that a control signal includes inaccurate or invalid information, such as an inaccurate control device identification.

The evaluation may include updating entity relationship information and priority information at 532. The entity relationship information may include information about entities associated with the MPC, such as users, MPUs, control units, media sources, media flows, or communication links. The entity relationship information may indicate the timing of a relationship, such as start time, stop time, or duration, and may indicate a type of relationship. For example, the entity relationship information may indicate that a specified control unit initiated a specified media flow.

The priority information may include priorities associated with the entities associated with the MPC, such as users, MPUs, control units, media sources, media flows, or communications links, and may be based on the identity of the entity or the type of the entity. For example, a user of a first control unit may be associated with a first priority based on the identity of the user, and a time based event, such as the expiration of a timer, may be associated with a second priority based on the type of the event.

The priority information may include one or more conditions associated with the priority. For example, a media flow may be associated with priority information indicating a high priority and a condition that a minimum presentation duration has not expired. The priority information may also indicate a low priority and a condition that no other priority associated with the media flow applies.

Control signals may include entity relationship information, priority information, or both. For example, a control signal may include priority information using a priority bit field. The entity relationship information, the priority information, or both, may be maintained in a data storage unit, such as a database, which may be included in the MPC or may be accessed by the MPC from a remote device. The entity relationship information, the priority information, or both, may be configured by a device manufacturer, a control unit, a MPC, an external device, or by a combination thereof. For example, a control unit may send a message to a MPC to assign a priority to a media flow.

The evaluation may include prioritizing the events at 534. The events may be prioritized based on policy information, status information, priority information, or a combination thereof. For example, the events may be prioritized based on a policy that indicates that events should be handled in the order received, such as in a first in first out method.

In another example, the events may be prioritized based on priorities of the entities associated with the event. For example, an event may indicate a control signal that includes a request to present a media flow. The event may be prioritized based on a priority associated with the media flow, a priority associated with the type of control unit that sent the control signal, or a priority associated with the identity of the control unit that sent the control signal, or a combination thereof.

The MPC may execute the events at 540. The MPC may determine how to execute the events based on the prioritization of the events, policy information, entity relationship information, priority information, or status information, and may control the MPUs to perform the actions indicated by the events. For example, an event may indicate a request to perform a media flow and the MPC may control a MPU to perform the media flow.

In another example, an event may indicate a request, received from a first control unit, to stop a media flow. The status information may indicate that the media flow is being performed by a MPU that is included in a remote device (remote MPU). The entity relationship information may indicate that a second control unit is associated with the remote device. The policy information may indicate that a control unit may not stop a media flow on a remote MPU that is associated with another control unit of equal or greater priority. The priority information may indicate that the first control unit has a higher priority than the second control unit. The MPC may stop the media flow.

The MPC may mark executed events as complete or may delete executed events. The MPC may update state information based on the execution of the event. The MPC may delay, reject, or delete unexecuted prioritized events based on an executed event. For example, an event may indicate a request to power-down the MPU. The MPC may execute the power-down request and may delete unexecuted events.

The MPC may report information to one or more associated entities at 550. The reported information may include an acknowledgment (ACK), or negative ACK (NACK), in response to a received signal. The reported information may indicate status information associated with an entity, including the MPC, or a request, such as priority information, time information, location information, or capability information. For example, the reported information may indicate that a request was successfully executed, or that a request was denied and may indicate a reason for the denial. The reported information may indicate a requirement. For example, the reported information may indicate that performance of an association method is required.

A control unit, which may be a remote device, may receive information from the MPC. The control unit may enable, disable, or modify a function based on information from the MPC. The control unit may indicate information from the MPC to a user. The control unit may send control signals to the MPC in response to information received from the MPC or in response to a failure to receive information from the MPC.

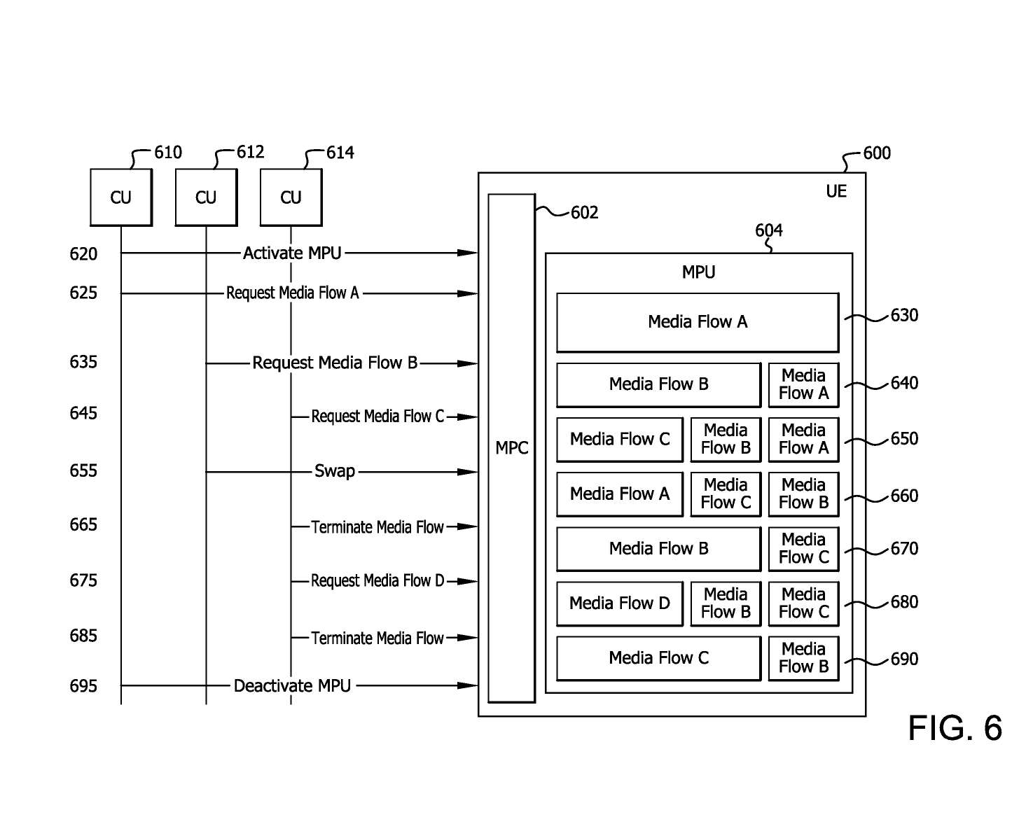

FIG. 6 is a diagram of an example of media performance management. A UE 600 may include a MPC 602 and a MPU 604. The UE 600 may receive control signals from a first control unit 610, a second control unit 612, and a third control unit 614. Although the UE 600 and the control units 610/612/614 are shown as logically separate units, the MPC 602, the MPU 604, and the control units 610/612/614, may be configured as one or more physical devices. For example, a first physical device may include the first control unit 610, such as a keyboard, and the MPC 602. A second physical device may include the second control unit 612 and the MPU 604. A third physical device may include the third control unit 614.

The UE 600 may receive a control signal from the first control unit 610 requesting activation of the MPU 604, and the MPC 602 may activate the MPU 604 at 620. The UE 600 may receive a control signal requesting performance of Media Flow A from the first control unit 610 at 625. The MPC 602 may control the MPU 604 to perform media flow A using the MPU's performance capabilities at 630. Although not shown in FIG. 6, the UE 600 may send a request for a media flow to a media source, which may be a remote device.

The UE 600 may receive a control signal indicating a request to perform Media Flow B from a second control unit 612 at 635. The MPC 602 may direct the MPU 604 to perform Media Flow B using a first portion of the MPU's performance capabilities, and to display Media Flow A using a second portion of the MPU's performance capabilities at 640. The first portion may larger than the second portion, such as in a picture-in-picture configuration; or the first portion may be the same size as the second portion, such as in a split screen configuration.

The UE 600 may receive a control signal indicating a request to perform Media Flow C from a third control unit 614 at 645. The MPC 602 may direct the MPU 604 to perform Media Flow C using a first portion of the MPU's performance capabilities, to display Media Flow B using a second portion of the MPU's performance capabilities, and to display Media Flow A using a third portion of the MPU's performance capabilities at 650.

The UE 600 may receive a control signal indicating a request to swap media flows from the second control unit 612 at 655. The MPC 602 may direct the MPU 604 to perform Media Flow A using a first portion of the MPU's performance capabilities, to display Media Flow C using a second portion of the MPU's performance capabilities, and to display Media Flow B using a third portion of the MPU's performance capabilities at 660.

The UE 600 may receive a control signal indicating a termination of a media flow from the third control unit 614 at 665. The MPC 602 may control the MPU 604 to perform Media Flow B using a first portion of the MPU's performance capabilities, and to display Media Flow C using a second portion of the MPU's performance capabilities at 670. Performance of Media Flow A may cease either implicitly or MPC 602 may explicitly control MPU 604 to cease display of Media Flow A.

The UE 600 may receive a control signal indicating a request to perform Media Flow D from the third control unit 614 at 675. The MPC 602 may direct the MPU 604 to perform Media Flow D using a first portion of the MPU's performance capabilities, to display Media Flow B using a second portion of the MPU's performance capabilities, and to display Media Flow C using a third portion of the MPU's performance capabilities at 680.

The UE 600 may receive a control signal indicating a termination of a Media Flow from the third control unit 614 at 685. The MPC 602 may control the MPU 604 to perform Media Flow C using a first portion of the MPU's performance capabilities, and to display Media Flow B using a second portion of the MPU's performance capabilities at 690.

The UE 600 may receive a control signal indicating a deactivation of the MPU 604 from the second control unit 612 and the MPC 602 may deactivate the MPU 604 at 695. The MPC 602 may determine that at least one media flow is being performed using the MPU 604 and may delay deactivating the MPU 604 until the active media flows terminate.

The MPC 602 may monitor media flows and control signals and may control the MPU 604 in response to a determination that no media flows have been recently performed, or in response to a determination that no control signals have been recently received. For example, the MPC 602 may reset a timer in response to receiving a control signal, and may control the MPU 604 to perform the predetermined media flow when the timer expires, or the MPC 602 may deactivate the MPU 604 when the timer expires.

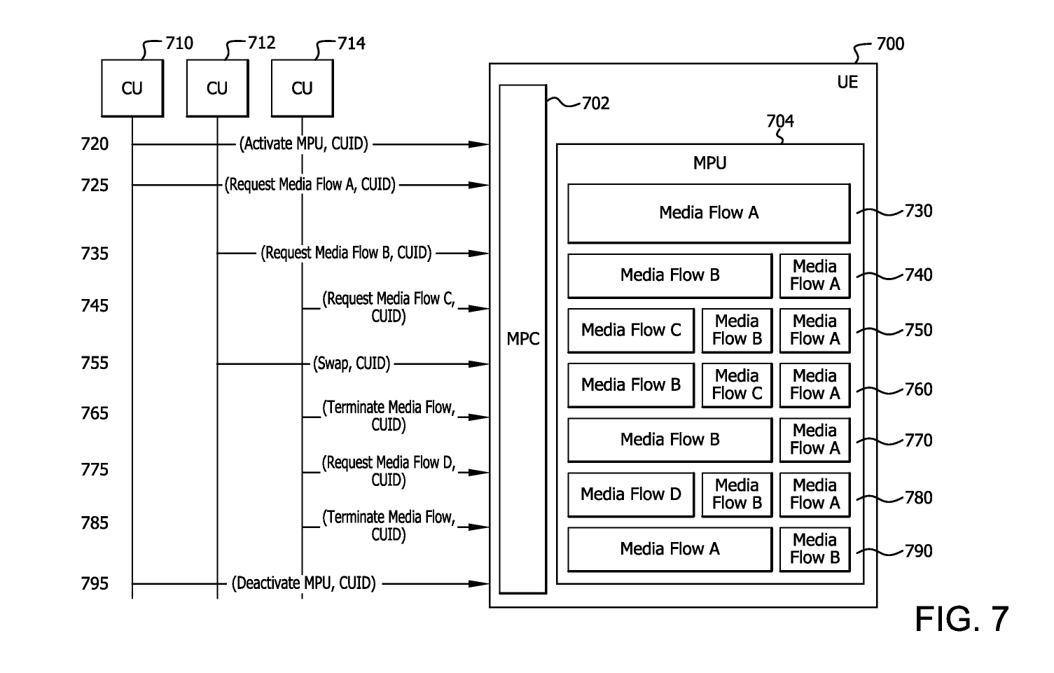

FIG. 7 is a diagram of an example of media performance management with control unit identification. The method and apparatus shown in FIG. 7 are similar to the method and apparatus shown in FIG. 6, except that the MPC 702 may associate control signals with source control units. A control signal may explicitly indicate a control unit, for example, using an ID bit field, or the MPC 702 may detect the source of a control signal based on a characteristic of the received signal, such as a frequency, a pattern, or a location of the transmitting control unit.

A UE 700, including a MPC 702 and a MPU 704, may receive a control signal from a first control unit 710 requesting activation of the MPU 704, and the MPC 702 may activate the MPU 704 at 720. The UE 700 may receive a control signal requesting performance of Media Flow A from the first control unit 710 at 725. The MPC 702 may control the MPU 704 to perform media flow A using the MPU's performance capabilities at 730.

The UE 700 may receive a control signal indicating a request to perform Media Flow B from a second control unit 712 at 735. The MPC 702 may control the MPU 704 to perform Media Flow B using a first portion of the MPU's performance capabilities, and to perform Media Flow A using a second portion of the MPU's performance capabilities at 740.

The UE 700 may receive a control signal indicating a request to perform Media Flow C from a third control unit 714 at 745. The MPC 702 may control the MPU 704 to perform Media Flow C using a first portion of the MPU's performance capabilities, to perform Media Flow B using a second portion of the MPU's performance capabilities, and to perform Media Flow A using a third portion of the MPU's performance capabilities at 750.

The UE 700 may receive a control signal indicating a request to swap media flows from the second control unit 712 at 755. The MPC 702 may detect that Media Flow B is associated with the second control unit 712 and may control the MPU 704 to perform Media Flow B using a first portion of the MPU's performance capabilities, to perform Media Flow C using a second portion of the MPU's performance capabilities, and to perform Media Flow A using a third portion of the MPU's performance capabilities at 760.

The UE 700 may receive a control signal indicating a termination of a Media Flow from the third control unit 714 at 765. The MPC 702 may detect that Media Flow C is associated with the third control unit 714 and may control the MPU 704 to perform Media Flow B using a first portion of the MPU's performance capabilities, and to perform Media Flow A using a second portion of the MPU's performance capabilities at 770.

The UE 700 may receive a control signal indicating a request to perform Media Flow D from the third control unit 714 at 775. The MPC 702 may control the MPU 704 to perform Media Flow D using a first portion of the MPU's performance capabilities, to perform Media Flow B using a second portion of the MPU's performance capabilities, and to perform Media Flow A using a third portion of the MPU's performance capabilities at 780.

The UE 700 may receive a control signal indicating a termination of a Media Flow from the third control unit 714 at 785. The MPC 702 may detect that Media Flow D is associated with the third control unit 714 and may control the MPU 704 to perform Media Flow A using a first portion of the MPU's performance capabilities, and to perform Media Flow B using a second portion of the MPU's performance capabilities at 790.

The UE 700 may receive a control signal indicating a deactivation of the MPU 704 from the first control unit 710 and the MPC 702 may deactivate the MPU 704 at 795.

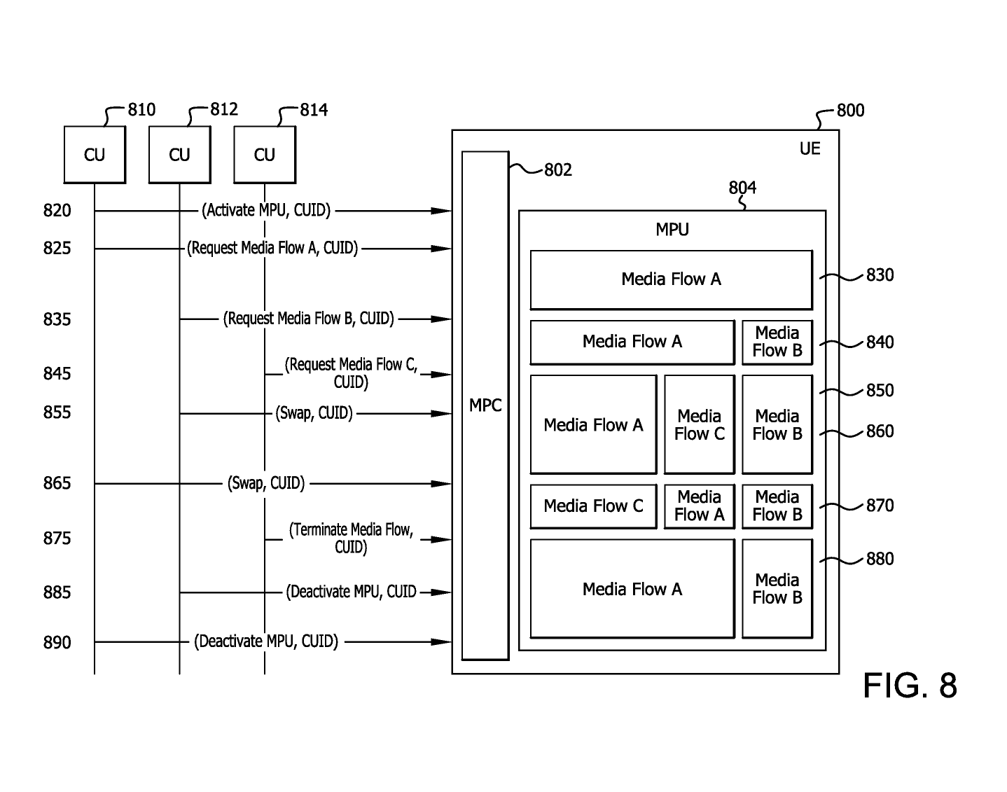

FIG. 8 shows a diagram of an example of media performance management with priority information. The method and apparatus shown in FIG. 8 are similar to the method and apparatus shown in FIGS. 6 and 7, except that the MPC 802 may access priority information. The MPC 802 may use the priority information to determine how to present the media flows.

A UE 800, including a MPC 802 and a MPU 804 may receive a control signal from a first control unit 810 requesting activation of the MPU 804, and the MPC 802 may activate the MPU 804 at 820. The UE 800 may receive a control signal requesting performance of Media Flow A from the first control unit 810 at 825. The MPC 802 may control the MPU 804 to perform media flow A using the MPU's performance capabilities at 830.

The UE 800 may receive a control signal indicating a request to perform Media Flow B from a second control unit 812 at 835. The MPC 802 may detect that the second control unit 812 is associated with a priority that is lower than a priority associated with the first control unit 810, and may control the MPU 804 to perform Media Flow A using a first portion of the MPU's performance capabilities, and to perform Media Flow B using a second portion of the MPU's performance capabilities at 840.

The UE 800 may receive a control signal indicating a request to perform Media Flow C from a third control unit 814 at 845. The MPC 802 may detect that the third control unit 814 is associated with a priority that is higher than the priority associated with the second control unit 812 and lower than the priority associated with the first control unit 810, and may control the MPU 804 to perform Media Flow A using a first portion of the MPU's performance capabilities, to perform Media Flow C using a second portion of the MPU's performance capabilities, and to perform Media Flow B using a third portion of the MPU's performance capabilities at 850.

The UE 800 may receive a control signal indicating a request to swap media flows from the second control unit 812 at 855. The MPC 802 may detect that the second control unit 812 is associated with the lowest priority and may reject the request at 860. The MPC 802 may indicate that the request is rejected. For example, the MPC 802 may control a MPU to perform an indication that the request is rejected, such as an audio indicator.

The UE 800 may receive a control signal indicating a request to swap media flows from the first control unit 810 at 865. The MPC 802 may detect that the first control unit 810 is associated with the highest priority, and may control the MPU 804 to perform Media Flow C using a first portion of the MPU's performance capabilities, to perform Media Flow A using a second portion of the MPU's performance capabilities, and to perform Media Flow B using a third portion of the MPU's performance capabilities at 870.

The UE 800 may receive a control signal indicating a termination of a media flow from the third control unit 814 at 875. The MPC 802 may control the MPU 804 to perform Media Flow A using a first portion of the MPU's performance capabilities and to perform Media Flow B using a second portion of the MPU's performance capabilities at 880.

The UE 800 may receive a control signal indicating a deactivation of the MPU 804 from the second control unit 812 at 885. The MPC 802 may detect that the second control unit 812 is associated with the lowest priority and may reject the request. The UE 800 may receive a control signal indicating a deactivation of the MPU 804 from the first control unit 810 at 890. The MPC 802 may detect that the first control unit 810 is associated with the highest priority and may deactivate the MPU 804 at 890.

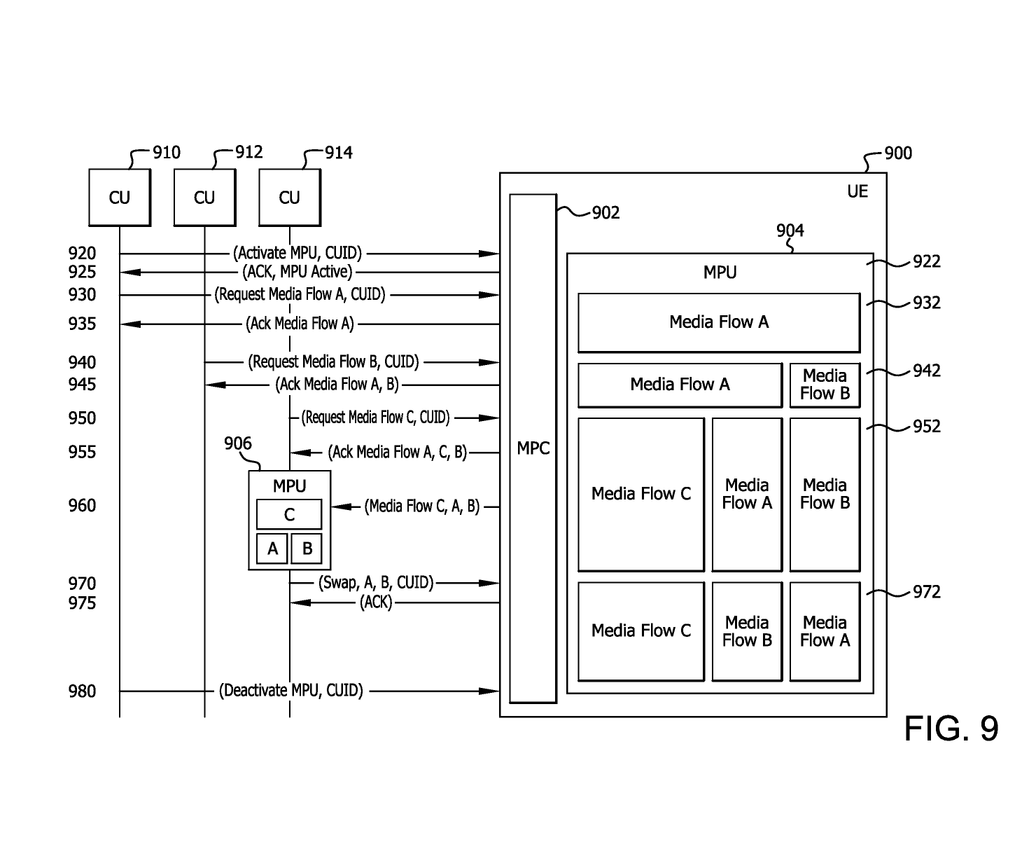

FIG. 9 is a diagram of an example of media performance management with bidirectional communication. The method and apparatus shown in FIG. 9 are similar to the method and apparatus shown in FIGS. 6, 7, and 8, except that the MPC 902 may report information to the control units.

A UE 900, including a MPC 902 and a MPU 904 may receive a control signal from a first control unit 910 requesting activation of the MPU 904 at 920. The MPC 902 may activate the MPU 904 at 922. The MPC 902 may report an acknowledgment to the first control unit 910 indicating that the MPU 904 is active at 925. The first control unit 910 may receive the reported information and may enable control signaling methods associated with the MPU 904. For example, the first control unit 910 may enable a user interface for controlling the MPU 904.

The UE 900 may receive a control signal requesting performance of Media Flow A from the first control unit 910 at 930. The MPC 902 may control the MPU 904 to perform media flow A using the MPU's performance capabilities at 932. The MPU 904 may report the performance of Media Flow A on the MPU 904 to the first control unit 910 at 935. The first control unit 910 may receive the reported information and may enable control signaling methods associated with Media Flow A.

The UE 900 may receive a control signal indicating a request to perform Media Flow B from a second control unit 912 at 940. The MPC 902 may detect that the second control unit 912 is associated with a priority that is lower than a priority associated with the first control unit 910. The MPU 902 may control the MPU 904 to perform Media Flow A using a first portion of the MPU's performance capabilities, and to perform Media Flow B using a second portion of the MPU's performance capabilities at 942. The MPU may report information to the second control unit 912 indicating the performance of Media Flow A and Media Flow B at 945. The second control unit 912 may receive the reported information and may enable control signaling methods associated with Media Flow B. Although not shown, the MPU may send the information to multiple associated control units, such as the first control unit 910.

The UE 900 may receive a control signal indicating a request to perform Media Flow C from a third control unit 914 at 950. The MPC 902 may detect that the third control unit 914 is associated with a highest priority. The MPC 902 may control the MPU 904 to perform Media Flow C using a first portion of the MPU's performance capabilities, to perform Media Flow A using a second portion of the MPU's performance capabilities, and to perform Media Flow B using a third portion of the MPU's performance capabilities at 952. The MPU may report information to the third control unit 914 indicating the performance of Media Flow C, Media Flow A, and Media Flow B at 955. Although not shown, the MPU may send the information to the first control unit 910 and the second control unit 912.

The UE 900 may report status information to a remote device at 960. For example a remote device may include the third control unit 912 and a second MPU 906. The third control unit 914 and the second MPU 906 may be configured as a single physical unit, such as a touchscreen. The status information may include the media flows, or portions of the media flows. The remote device may generate a user interface using the media flows, or partial media flows, the third control unit 912, and the second MPU 906. A user of the remote device may use the user interface to swap Media Flow A with Media Flow B.

The UE 900 may receive a control signal indicating a request to swap Media Flow A with Media Flow B from the third control unit 914 at 970. The MPC 902 may detect that the third control unit 914 is associated with the highest priority, and may control the MPU 904 to perform Media Flow C using a first portion of the MPU's performance capabilities, to perform Media Flow B using a second portion of the MPU's performance capabilities, and to perform Media Flow A using a third portion of the MPU's performance capabilities at 972. The MPU may report an acknowledgment to the third control unit 914 at 975. Although not shown, the MPU may report the swap to the first control unit 910 and the second control unit 912.

The UE 900 may receive a control signal indicating a deactivation of the MPU 904 from the first control unit 910 and may deactivate the MPU 904 at 980.

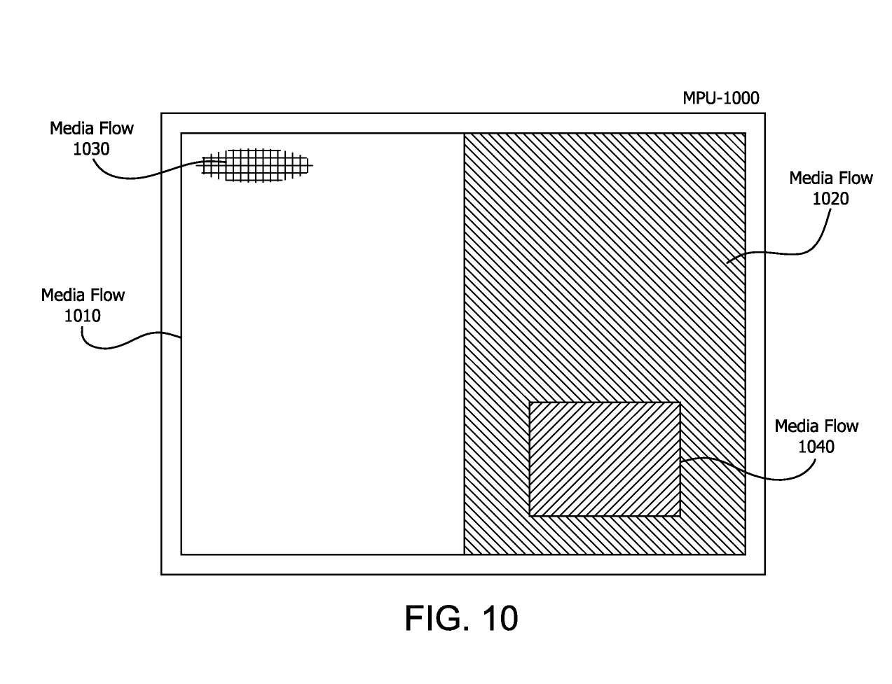

FIG. 10 shows a diagram of an example of a media performance unit. The MPU 1000 may concurrently perform four media flows 1010/1020/1030/1040. The MPU 1000 may perform the first media flow 1010 and the second media flow 1020 using a split screen as shown. The MPU 1000 may perform the third media flow 1030 using a layer over the performance of the first media flow 1010 as shown. The MPU 1000 may perform the fourth media flow 1040 using a picture-in-picture with the second media flow 1020 as shown.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method of media performance management comprising:
controlling a performance of a first media flow on a media performance unit (MPU) by:
detecting a first event, wherein the first event is associated with the performance, the first media flow, the MPU, a control unit, a media source, a user, a communication link, a relationship, a policy, or a second event;
evaluating the first event; and
executing an action associated with the first event.

2. The method of claim 1, wherein the detecting includes detecting a plurality of events, such that the first event is one of the plurality of events; and
the evaluating includes prioritizing the plurality of events.

3. The method of claim 1, wherein the detecting includes receiving a control signal.

4. The method of claim 1, wherein the evaluating includes processing relationship information, priority information, status information, event information, or policy information.

5. The method of claim 4, wherein the evaluating includes modifying the relationship information or the priority information.

6. The method of claim 1, wherein the executing includes analyzing policy information, status information, relationship information, or priority information.

7. The method of claim 1, wherein the controlling includes:
controlling the MPU to perform the first media flow using a first portion of a media performance capability of the MPU; and
controlling the MPU to perform a second media flow using a second portion of the media performance capability of the MPU.

8. The method of claim 1, wherein the controlling includes controlling a plurality of MPUs.

9. The method of claim 1, wherein the detecting includes identifying a status associated with the first event and the control unit, the media source, the MPU, the user, the relationship, the policy, the communication link, or the second event.

10. An apparatus for use in media performance management, the apparatus comprising:
a media performance controller configured to control a performance of a first media flow on a media performance unit (MPU) by:
detecting a first event, wherein the first event is associated with the performance, the first media flow, the MPU, a control unit, a media source, a user, a communication link, a relationship, a policy, or a second event;
evaluating the first event; and
executing an action associated with the first event.

11. The apparatus of claim 10, wherein the media performance controller is configured to detect a plurality of events, such that the first event is one of the plurality of events; and
to prioritize the plurality of events.

12. The apparatus of claim 10, further comprising:
a receiver configured to receive a control signal, wherein the media performance controller is configured to detect the first event in response to the receiver.

13. The apparatus of claim 10, wherein the media performance controller is configured to evaluate the first event by processing relationship information, priority information, status information, event information, or policy information.

14. The apparatus of claim 13, wherein the media performance controller is configured to evaluate the first event by modifying the relationship information or the priority information.

15. The apparatus of claim 10, wherein the media performance controller is configured to execute the first event by analyzing policy information, status information, relationship information, or priority information.

16. The apparatus of claim 15, wherein the media performance controller is configured to control the performance by:
controlling the MPU to perform the first media flow using a first portion of a media performance capability of the MPU; and
controlling the MPU to perform a second media flow using a second portion of the media performance capability of the MPU.

17. The apparatus of claim 10, further comprising the MPU.

18. A method of media performance management comprising:
controlling a media performance unit (MPU) to concurrently perform a plurality of media flows wherein each media flow in the plurality of media flows is associated with a priority such that a first media flow selected from the plurality of media flows is performed using a first portion of a media performance capability of the MPU and a second media flow selected from the plurality of media flows is performed using a second portion of the media performance capability of the MPU.

19. The method of claim 18, further comprising:
detecting a plurality of events such that each event in the plurality of events is associated with a media flow in the plurality of media flows, the MPU, a control unit, a media source, a user, a communication link, a relationship, a policy, or another event in the plurality of events; wherein the controlling is performed in response to the detecting.

20. The method of claim 19, wherein the detecting includes receiving a plurality of control signals such that each control signal in the plurality of control signals is associated with a control unit.
